(19) United States
(12) Patent Application Publication
(10) Pub. No.: US 2011/0222138 A1
(43) Pub. Date: Sep. 15, 2011

(54) ELECTRICALLY CONTROLLABLE DEVICE HAVING IMPROVED TRANSPORTATION OF THE ELECTRIC CHARGES OF THE ELECTROACTIVE MEDIUM

(75) Inventors: Fabienne Piroux, La Plaine Saint Denis (FR); Gilles Bokobza, Paris (FR); Martine Giret, Gagny (FR)

(73) Assignee: Saint-Gobain Glass France, Courbevoie (FR)

(21) Appl. No.: 13/130,538

(22) PCT Filed: Dec. 1, 2009
(86) PCT No.: PCT/EP2009/066167

§ 371 Date: May 20, 2011

(30) Foreign Application Priority Data
Dec. 5, 2008 (FR) 0858289

(51) Int. Cl. G02F 1/15

(52) U.S. Cl. 359/268; 359/265; 359/275

(57) ABSTRACT

This device comprises the following stack of layers: a first substrate having a glass function (V₁); a first electronically conductive layer (TCC₁) with an associated current feed; an electroactive system (EA); a second electronically conductive layer (TCC₂) with an associated current feed; and a second substrate having a glass function (V₂). Each current feed is constituted by a continuous conductive strip (1-1a; 2-2a) applied to the associated electronically conductive layer, said conductive strip being positioned over the entire perimeter or substantially over the entire perimeter of said layer (TCC₁; TCC₂) so as to strengthen the conductivity thereof and being connected to the electrical power supply via one of its ends.

The present invention relates to an electrically controllable device having variable optical/energy properties, comprising the following stack of layers:
a first substrate having a glass function (V₁);
a first electronically conductive layer (TCC₁) with an associated current feed;
an electroactive system (EA) comprising or constituted by:
   at least one electroactive organic compound (ea₁⁺) capable of being reduced and/or of accepting electrons and cations acting as compensation charges;
   at least one electroactive organic compound (ea₂) capable of being oxidized and/or of ejecting electrons and cations acting as compensation charges;
   at least one of said electroactive organic compounds (ea₁⁺ and ea₂) being electrochromic in order to obtain a color contrast; and
   ionic charges capable of allowing, under the action of an electric current, oxidation and reduction reactions of said electroactive organic compounds (ea₁⁺ and ea₂), which reactions are necessary in order to obtain the color contrast;
a second electronically conductive layer (TCC₂) with an associated current feed; and
a second substrate having a glass function (V₂).

The electronically conductive layers are denoted by “TCC”, an abbreviation for the expression “transparent conductive coating”, one example of which is a TCO (“transparent conductive oxide”).

The electroactive medium (ea) is a medium that is in solution or that is gelled. It may also be contained in a self-supported polymer matrix such as is described in International application PCT/FR2008/051160 filed on 25, May 2008 or in European application EP 1 786 883.

In the case where the two electroactive materials are electrochromic materials, these may be identical or different. In the case where one of the electroactive materials is electrochromic and the other is not, the latter will have the role of a counter electrode that does not participate in the coloring and bleaching processes of the system.

If it is assumed that the compound (ea₁⁺) is electrochromic (being, for example, 1,1′-diethyl-4,4′-bipyridinium diperchlorate) and that the compound (ea₂) is electrochromic (being, for example, 5,10-dihydro-5,10-dimethylphenazine) or is not electrochromic (being, for example, a ferrocene), the redox reactions that are established under the action of the electric current are the following:

ea₁⁺+e⁻≈ea₁
colored

ea₂≈ea₂⁺+e⁻
colored if electrochromic
colorless if not electrochromic

In such known devices and in accordance with a first prior art, each current feed consists of a thin conductive strip applied along one edge of the associated electronically conductive layer, the two strips being placed along two opposite edges of the electrically controllable device.

FIGS. 1 to 3 from the appended drawing schematically illustrate a rear view mirror in accordance with this prior art.

This rear view mirror comprises two sheets of glass V1, V2, positioned facing each other, one being offset downwards in order to fulfill objectives of mounting in the frame of the rear view mirror. The inner faces of each of these sheets V₁, V₂ are coated with an electronically conductive layer, respectively TCC₁, TCC₂, constituted, in particular, by a TCO (abbreviation of “transparent conductive oxide”). Between the two facing regions of the sheets V₁, V₂ thus coated, is a “reservoir” zone filled with an electroactive medium EA, which is in solution or gelled, this reservoir being sealed over its entire periphery by an electrically insulating encapsulation seal J.

The current feeds to the layers TCC₁, TCC₂ respectively, are achieved by foils 1, 2, respectively, each constituted by a metal strip in an L-shape, of which one of the arms is applied to the edge of the coated glass V₁, V₂ and of which the other arm is applied against the part of the layer TCC₁, TCC₂ that juts out beyond the “reservoir” part. The foils 1, 2 are applied respectively along the upper edge and along the lower edge of the rear view mirror.

For the following explanation, as compound ea₁⁺, 1,1′-diethyl-4,4′-bipyridinium diperchlorate (electro-chromic) will be chosen and, as compound ea₂, 5,10-dihydro-5,10-dimethylphenazine (electrochromic) or ferrocene (not electrochromic or counter electrode that does not participate in the coloring process of the system) will be chosen.

In an ideal system, when no voltage is applied to the device, the active medium, in which the ea₁⁺ and ea₂⁻ species are found, is colorless and, when a voltage is applied, the ea₁⁺ species are reduced to ea₁ species, the latter being uniformly distributed in the vicinity of the surface of the electronically conductive layer connected to the − sign pole of the electrical power supply, that is to say to the cathode of the glazing unit and, similarly, the ea₂ species are oxidized to ea₂⁺ species, the latter being uniformly distributed in the vicinity of the surface of the electronically conductive layer connected to the + sign pole of the electrical power supply, that is to say to the anode of the glazing unit, the panel then appearing as a uniform color corresponding to the uniform mixture of the ea₁ and ea₂⁺ species.

However, in reality, during the application of an electric current and when this current is cut off, a phenomenon of segregation of phases between the pairs of (ea₁, ea₁⁺) and (ea₂, ea₂⁺) species, and especially between the ea₁ and ea₂⁺species, occurs. This phenomenon decreases over time once the bleaching process has started or during the coloring obtained after reversal of the poles of the electrical power supply, but which may still remain for a very long time, or even still remain when the change of state of the electrically controllable device is again ordered, so much so that in this case the uniform colors that are desired, whether this is during the colored state or the bleached state, are never obtained.

This segregation phenomenon is due to the preferential reduction of the ea₁⁺ species to ea₁ species around the zone of greater electrical intensity of the cathode and, reciprocally, to the preferential oxidation of the ea₂ species to ea₂⁺ species around the zone of greater electrical intensity of the anode, these two zones of greater electrical intensity being those of the foils.

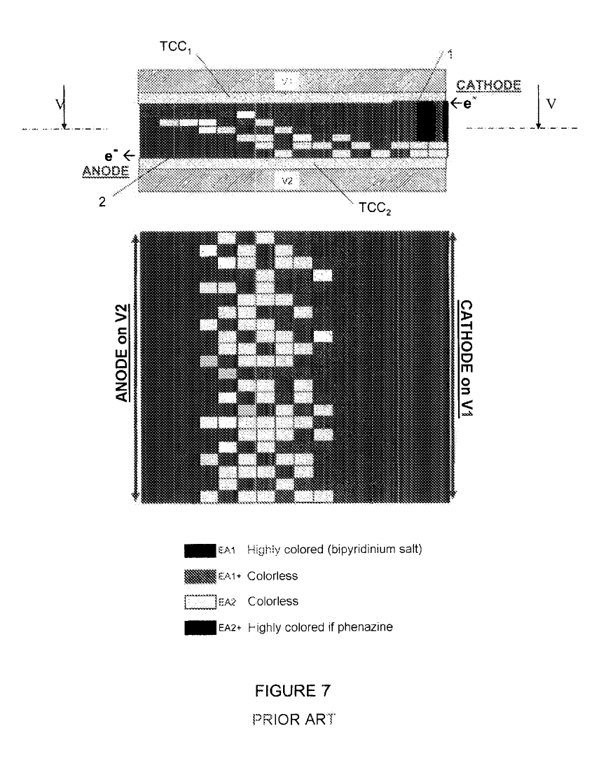

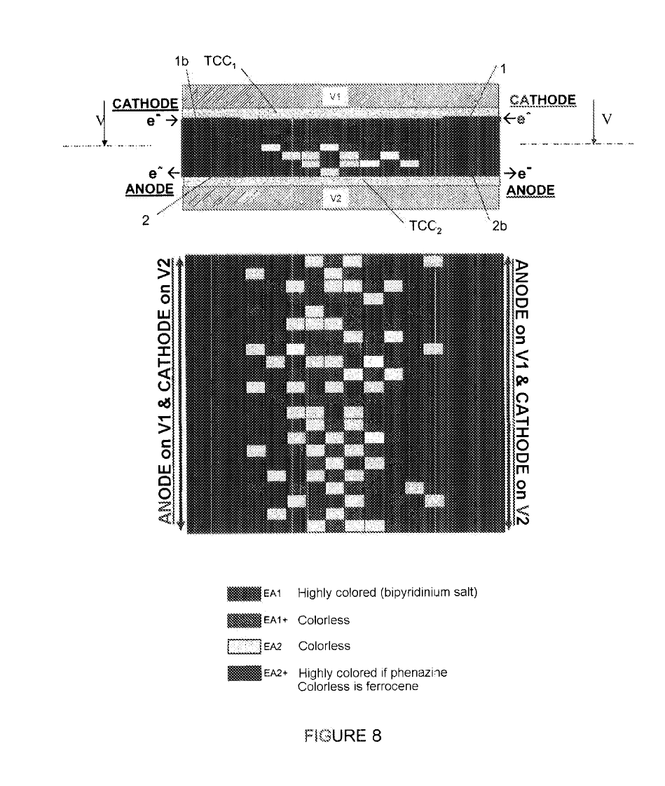

FIG. 7 of the appended drawing, of which the upper part schematically shows a cross section of the known electrically controllable device and its lower part, a front view of the panel under voltage, illustrates this typical segregation phenomenon of the devices from the prior art with two zones: on the one hand, colored ea₁ species and, on the other hand, ea₂⁺ species that are colored another color. FIG. 1 thus shows the zones of accumulation of ea₁ and of ea₂⁺ when a voltage is applied to the electrically controllable device and, consequently, the appearance of a color mainly due to the ea₁ species around the cathode (on the right-hand side in the front view), this color gradually degrading to a new color mainly due to the ea₂⁺ species around the anode (on the left-hand side in the front view).

The segregation phenomenon is furthermore even greater when the panel of the electrically controllable device is larger, and currently prevents a commercial exploitation of large-size electrically controllable devices, such as electrically controllable glazing units for buildings.

In accordance with a second prior art represented by PCT International application WO 03/012541 A2, according to which it is proposed to solve the problem of phase segregation via an alternation, over the entire perimeter of the electrically controllable device, of small foils intended to be used as anodes and of small foils intended to be used as cathodes, the first all being connected to one another and the second all being connected to one another. A homogeneity of the coloring is not however achieved with such an arrangement of foils, the segregation phenomenon in fact continues to occur at each foil, which also has, in particular, the effect of limiting the color contrast of the device.

EP-A-113 313 describes an electrochromic mirror comprising a transparent conductive substrate, a reflective conductive substrate and a layer that conducts ions positioned between the two, at least one of said substrates being provided on the peripheral portion of its conductive surface with a highly conductive layer that has a resistance below the surface resistance of said conductive surface.

U.S. Pat. No. 5,293,546 describes a working electrode that comprises an electrically conductive metal grid or bus having a coating of metal oxide. The grid is positioned under the oxide coating.

The applicant company therefore sought an effective means for avoiding the phase segregation described above both in the colored state and during bleaching or in the bleached state regardless of the time during which the glazing has been maintained in the colored state by application of an electric current.

At the same time, the applicant company also sought, for such electrically controllable devices, in particular those of large size, a good light transmission in the colored state, a good contrast and a good cell coloration rate.

These objectives were achieved according to the present invention by virtue of the use of current feed conductive strips that are not limited to being found along a single edge of the associated TCC₁ or TCC₂ layer, but that extend over the entire perimeter of this layer, with the possibility of forming a grid applied over the entire surface of the TCC₁ or TCC₂ layer.

One subject of the present invention is therefore an electrically controllable device having variable optical/energy properties, comprising the stack of layers as defined at the very beginning of this description, characterized in that each current feed is constituted by a continuous conductive strip applied to the associated electronically conductive layer, said conductive strip being positioned over the entire perimeter or substantially over the entire perimeter of said layer (TCC₁; TCC₂) so as to strengthen the conductivity thereof and being connected to the electrical power supply via one of its ends.

Advantageously, the two continuous conductive strips are placed with an offset (or interval or shift) relative to one another, which offset is preferably less than or equal to 2 cm. This arrangement makes it possible to avoid short-circuit phenomena between two conductive strips.

For cost reasons, it is preferable to use conductive strips having a thickness substantially greater than or equal to 50 microns. Similarly, the electroactive system preferably has a thickness of the order of 100 microns. Consequently, such conductive strips associated with the electronically conductive layers opposite must be offset so as not to touch one another, so that the potential difference between two conductive strips does not cause a short circuit.

The conductive strip may be a metal, an alloy or an electrically conductive composite. This conductive strip may especially be deposited directly onto the substrates or the spacers using, for example, a technique of screen printing with a metallic paste, or welded to the substrates or the spacers or else bonded using an electrically conductive adhesive.

Thus, in accordance with a first embodiment, a conductive strip is applied to each electronically conductive layer (TCC₁; TCC₂), especially by bonding or welding, along a first edge of said layer (TCC₁; TCC₂) and, at its end opposite the start of the strip, it is folded upon itself at 90° in order to be applied along the edge of the layer (TCC₁; TCC₂) perpendicular to the aforementioned edge, then again at 90° in order to be applied along the edge opposite to the latter, and finally at 90° in order to be applied in the vicinity of the remaining edge stopping in the vicinity of the start of the strip, this strip jutting out beyond the stack of layers that forms the electrically controllable device in order to form a connection with an electrical power supply.

In the case where the two substrates having a glass function (V₁; V₂) coated internally by their electronically conductive layer (TCC₁; TCC₂) are separated by a peripheral spacer frame that delimits, with these layers, an internal space for receiving the electroactive medium (EA) and are sealed by a peripheral seal, each conductive strip may be applied, via one of its faces, to the associated layer (TCC₁; TCC₂), and via its other face against said spacer frame.

In accordance with a second embodiment, a continuous peripheral conductive strip is deposited by screen printing onto each of the electronically conductive layers (TCC₁; TCC₂), a foil being applied to the start of said strip so as to jut out beyond the stack of layers that forms the electrically controllable device in order to form a connection with an electrical power supply.

A grid pattern supplied by the associated conductive strip may be formed on the surface of at least one electronically conductive layer (TCC₁; TCC₂).

The substrates having a glass function may be chosen from glass and transparent polymers, such as polymethyl methacrylate (PMMA), polycarbonate (PC), polyethyleneterephthalate (PET), polyethylene naphthoate (PEN) and cycloolefin copolymers (COCs).

The electronically conductive layers are layers of metallic type, such as layers of silver, of gold, of platinum and of copper; or layers of transparent conductive oxide (TCO) type, such as layers of tin-doped indium oxide (In₂O₃:Sn or ITO), of antimony-doped indium oxide (In₂O₃:Sb), of fluorine-doped tin oxide (SnO₂:F) and of aluminum-doped zinc oxide (ZnO:Al); or multilayers of TCO/metal/TCO type, the TCO and the metal being chosen, in particular, from those listed above; or multilayers of NiCr/metal/NiCr type, the metal being chosen, in particular, from those listed above.

The TCC₁ and TCC₂ layers may also be in the form of a grid or a microgrid. They may also comprise an organic and/or inorganic underlayer, especially in the case of plastic substrates, as described in International application WO 2007/057605.

In accordance with a first variant, the electroactive system (EA) may comprise a self-supported polymer matrix, inserted into which are the electroactive organic compound or compounds (ea₁⁺ & ea₂) and the ionic charges, said polymer matrix containing within it a liquid (L) that solubilizes said electroactive compounds (ea₁⁺& ea₂) and also the respectively associated reduced and oxidized species (ea₁ & ea₂⁺) and said ionic charges but that does not solubilize said self-supported polymer matrix, the latter being chosen to provide a percolation pathway for ionic charges in order to make said oxidation and reduction reactions of said electroactive organic compounds (ea₁⁺ & ea₂) possible; the ionic charges being borne by at least one of said electroactive organic compounds (ea₁⁺ & ea₂) and/or reduced and oxidized species which are respectively associated with them (ea₁ & ea₂⁺) and/or by at least one ionic salt and/or at least one acid solubilized in said liquid (L) and/or by said self-supported polymer matrix; the liquid (L) being constituted by a solvent or a mixture of solvents and/or by at least one ionic liquid or molten salt at ambient temperature, said ionic liquid or molten salt or said ionic liquids or molten salts then constituting a liquid (L) bearing ionic charges, which charges represent all or some of the ionic charges of said electroactive system.

In accordance with a second variant, the electroactive system may comprise a solution or a gel containing the electroactive organic compounds (ea₁⁺ & ea₂).

In accordance with a third variant, the electroactive system may be a self-supported and plasticized polymer film containing the electroactive organic compounds (ea₁⁺ & ea₂).

The electroactive organic compound(s) (ea₁⁺) may be chosen from bipyridiniums or viologens such as 1,1′-diethyl-4,4′-bipyridinium diperchlorate, pyraziniums, pyrimidiniums, quinoxaliniums, pyryliums, pyridiniums, tetrazoliums, verdazyls, quinones, quinodimethanes, tricyanovinylbenzenes, tetracyanoethylene, polysulfides and disulfides, and also all the electroactive polymer derivatives of the electroactive compounds that have just been mentioned; and the electroactive organic compound(s) (EA₂) is or are chosen from metallocenes, such as cobaltocenes, ferrocenes, N,N,N′,N′-tetramethylphenylenediamine (TMPD), phenothiazines such as phenothiazine, dihydrophenazines such as 5,10-dihydro-5,10-dimethylphenazine, reduced methylphenothiazone (MPT), methylene violet bernthsen (MVB), verdazyls, and also all the electroactive polymer derivatives of the electroactive compounds that have just been mentioned.

The ionic salt(s) may be chosen from lithium perchlorate, trifluoromethanesulfonate or triflate salts, trifluoromethanesulfonylimide salts and ammonium salts; the acid(s) is (are) chosen from sulfuric acid (H₂SO₄), triflic acid (CF₃SO₃H), phosphoric acid (H₃PO₄) and polyphosphoric acid (Hₙ₊₂PₙO₃ₙ₊₁) ; the solvent(s) is (are) chosen from dimethylsulfoxide, N,N-dimethylformamide, N,N-dimethylacetamide, propylene carbonate, ethylene carbonate, N-methyl-2-pyrrolidone(1-methyl-2-pyrrolidinone), y-butyrolactone, ethylene glycols, alcohols, ketones, nitriles and water; the ionic liquid(s) is (are) chosen from imidazolium salts, such as 1-ethyl-3-methylimidazolium tetrafluoroborate (emim-BF₄), 1-ethyl-3-methylimidazolium trifluoromethane sulfonate (emim-CF₃SO₃), 1-ethyl-3-methylimidazolium bis(trifluoromethyl sulfonyl)imide (emim-N(CF₃SO₂)₂ or emim-TSFI) and 1-butyl-3-methylimidazolium bis(trifluoromethylsulfonyl)imide (bmim-N(CF₃SO₂)₂ or bmim-TSFI).

The self-supported polymer matrix may be constituted by at least one polymer layer in which said liquid has penetrated to the core.

The polymer constituting at least one layer may be a homopolymer or copolymer that is in the form of a film that is non-porous but capable of swelling in said liquid, or that is in the form of a porous film, said porous film optionally being capable of swelling in the liquid comprising ionic charges and the porosity of which after swelling is chosen in order to allow the percolation of ionic charges in the thickness of the liquid-impregnated film.

The polymer material constituting at least one layer may also be chosen from:
homopolymers or copolymers that do not comprise ionic charges, in which case these charges are carried by at least one aforementioned electroactive organic compound and/or by at least one ionic salt or dissolved acid and/or by at least one ionic liquid or molten salt;
homopolymers or copolymers comprising ionic charges, in which case supplementary charges that make it possible to increase the percolation rate may be carried by at least one aforementioned electroactive organic compound and/or by at least one ionic salt or dissolved acid and/or by at least one ionic liquid or molten salt; and
blends of at least one homopolymer or copolymer that do not carry ionic charges and of at least one homopolymer or copolymer comprising ionic charges, in which case supplementary charges that make it possible to increase the percolation rate may be carried by at least one aforementioned electroactive organic compound and/or by at least one ionic salt or dissolved acid and/or by at least one ionic liquid or molten salt.

The polymer matrix may be made up of a film based on a homopolymer or copolymer comprising ionic charges, capable of giving, by itself, a film essentially capable of providing the desired percolation rate for the electroactive system or a percolation rate greater than this and on a homopolymer or copolymer that may or may not comprise ionic charges, capable of giving, by itself, a film that does not necessarily make it possible to provide the desired percolation rate, but that is essentially capable of ensuring the mechanical behavior, the contents of each of these two homopolymers or copolymers being adjusted so that both the desired percolation rate and the mechanical behavior of the resulting self-supporting organic active medium are ensured.

The polymer or polymers of the polymer matrix that do not comprise ionic charges may be chosen from copolymers of ethylene, of vinyl acetate and optionally of at least one other comonomer, such as ethylene/vinyl acetate copolymers (EVA); polyurethane (PU); polyvinyl butyral (PVB); polyimides (PI); polyamides (PA); polystyrene (PS); polyvinylidene fluoride (PVDF); polyetheretherketones (PEEK); polyethylene oxide (POE); epichlorohydrin copolymers and polymethyl methacrylate (PMMA); and

the polymer or polymers of the polymer matrix bearing ionic charges or polyelectrolytes are chosen from sulfonated polymers which have undergone an exchange of the H⁺ ions of the SO₃H groups with the ions of the desired ionic charges, this ion exchange having taken place before and/or at the same time as the swelling of the polyelectrolyte in the liquid comprising ionic charges, the sulfonated polymers especially being chosen from sulfonated copolymers of tetrafluoroethylene, polystyrene sulfonates (PSS), copolymers of sulfonated polystyrene, poly(2-acrylamido-2-methyl-1-propanesulfonic acid) (PAMPS), sulfonated polyetheretherketones (PEEK) and sulfonated polyimides.

The electrically controllable device of the present invention is especially configured in order to form: a sunroof for a motor vehicle, that can be activated autonomously, or a side window or a rear window for a motor vehicle or a rear view mirror; a windshield or a portion of a windshield of a motor vehicle, of an aircraft or of a ship, a vehicle sunroof; an aircraft cabin window; a display panel for displaying graphical and/or alphanumeric information; an interior or exterior glazing unit for buildings; a skylight; a display cabinet or store counter; a glazing unit for protecting an object of the painting type; an anti-glare computer screen; glass furniture; and a wall for separating two rooms inside a building.

In order to better illustrate the subject of the present invention, two particular embodiments thereof will be described in greater detail hereinbelow, with reference to the appended drawing.

In this drawing:

FIG. 1 is a schematic front view of a rear view mirror according to the prior art;

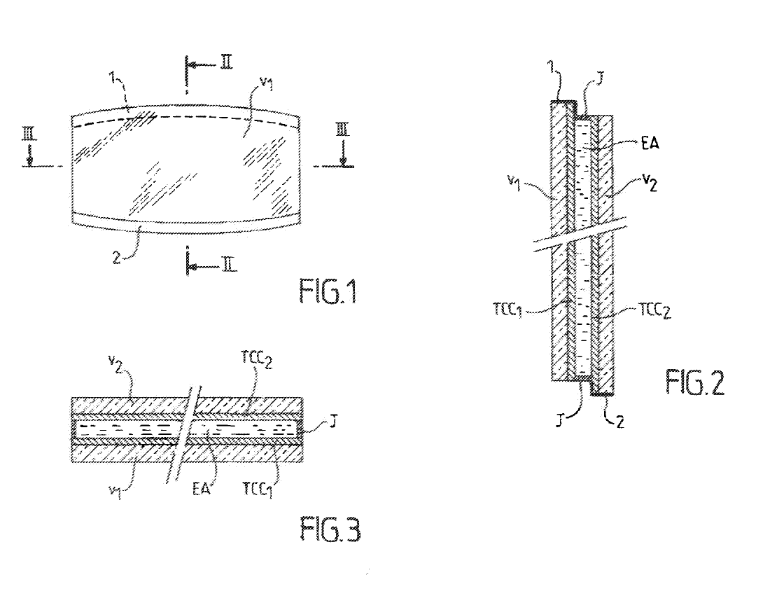

FIGS. 2 and 3 are schematic cross-sectional views along II-II and III-III respectively from FIG. 1;

FIG. 4 is a schematic cross-sectional view of a glazing unit according to the invention;

FIG. 5 is a view that corresponds to FIG. 4 showing one embodiment variant of the glazing unit;

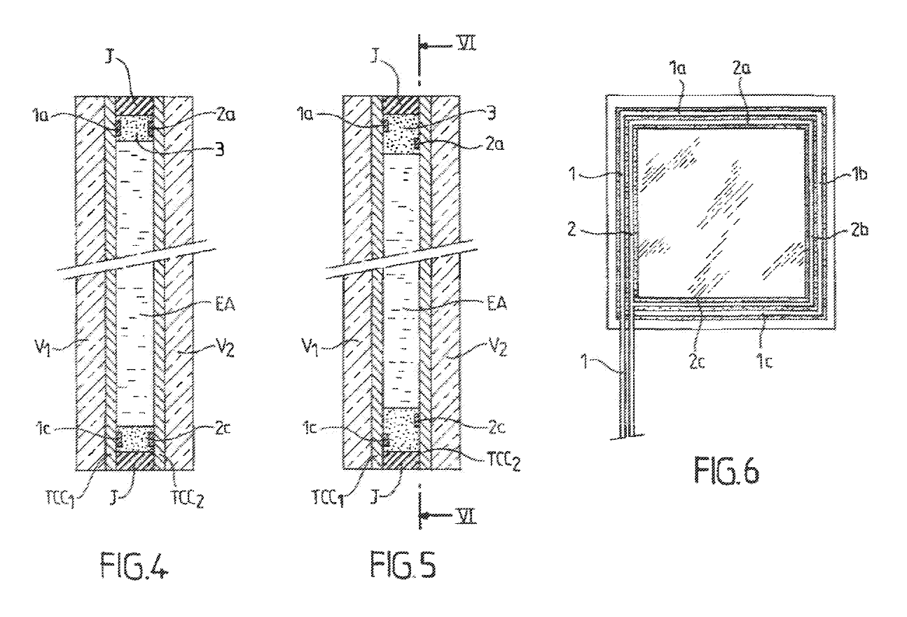

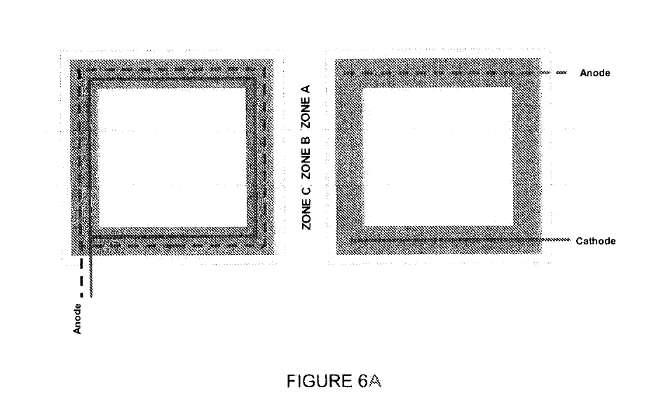

FIG. 6 is a cross-sectional view along VI-VI from FIG. 5;

FIG. 6A shows two views that schematically represent a cross section of that from FIG. 6, enabling the zones A, B and C to be observed on a glazing unit from the prior art (right-hand diagram) and a glazing unit according to the invention (left-hand diagram);

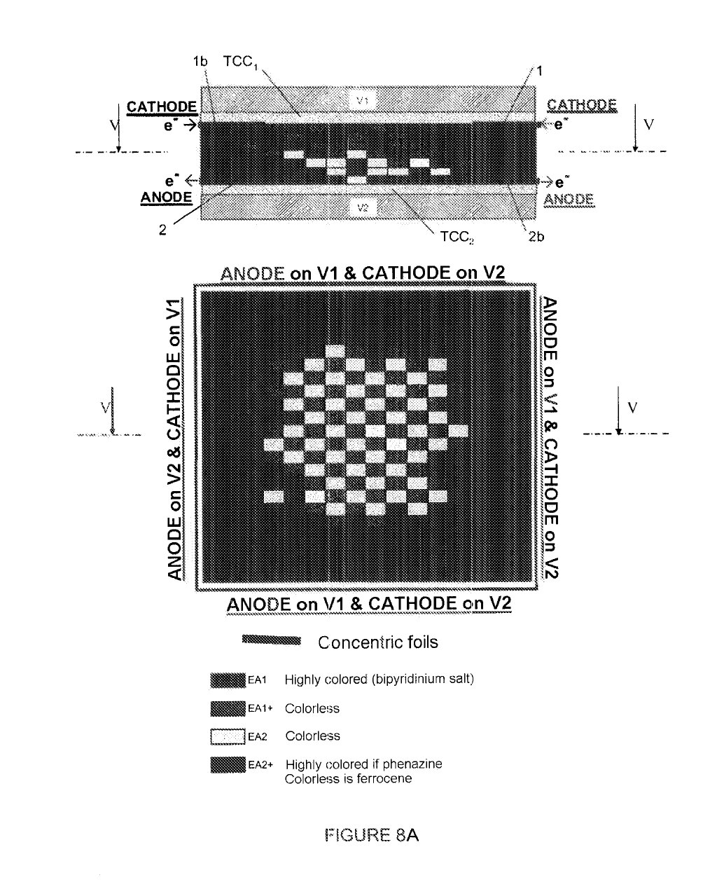

FIGS. 7, 8 and 8A are schematic views that illustrate the development of the coloration (symbolized by colored rectangles) respectively according to the prior art (FIG. 7) and according to the present invention (FIGS. 8 and 8A), FIG. 8A further illustrating the phenomenon known as the halo phenomenon, according to which, by virtue of the strips positioned on the two conductive layers and over their entire periphery, a homogeneous distribution of the ea₁ and ea₁⁺ species is obtained over the entire perimeter; and

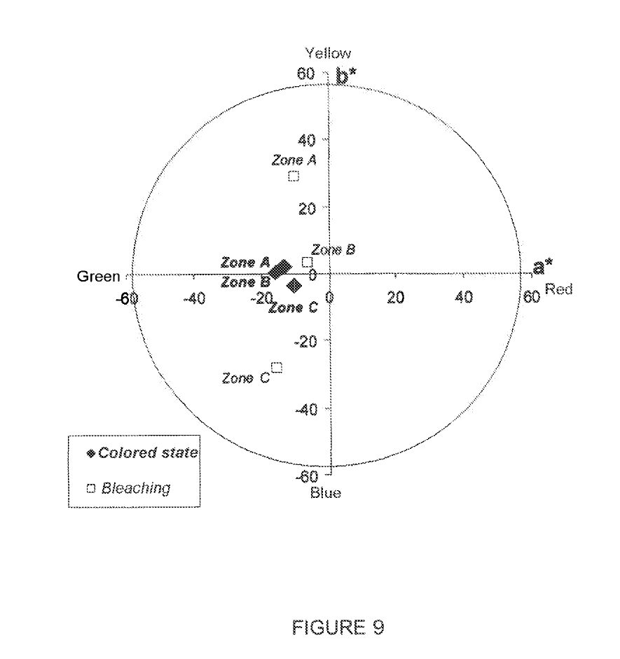

FIGS. 9 to 12 each represent the chromaticity coordinates of Examples 1 (comparative), 2, 4 (comparative) and 5 respectively in the CIELAB color space—measurements taken in zones A and/or B and/or C as indicated in FIG. 6A.

With reference to FIGS. 4 to 6, it is seen that two variants of a glazing unit according to the invention have been represented, the glazing unit comprising two opposite sheets of glass, V₁, V₂, each coated with their TTC₁ and TTC₂ layers respectively, separated by a spacer frame 3 made of double-sided adhesive with a polyester core and sealed by an external encapsulation seal J. The frame 3 and the two coated glass sheets delimit the internal space for receiving the EA medium.

Applied to each of the coated glass sheets is a current feed conductive strip, this comprising a length 1 along one edge as in the case of the prior art of FIGS. 1 to 3, but that extends via three successive lengths 1a, 1b and 1c and 2a, 2b and 2c respectively, each in the vicinity of one of the three remaining edges.

The aforementioned thin strips are folded upon themselves each time by 90° at their corners. They are facing the spacer frame 3, being opposite one another in the variant of FIG. 4 but slightly offset from one another in the variant of FIGS. 5 and 6.

The assembling of the glazing unit and the encapsulation of the EA medium are carried out conventionally, the current feed strips having previously been welded or bonded to the perimeter of the corresponding coated glass sheet.

The following examples illustrate the present invention without, however, limiting the scope thereof. In these examples, the following abbreviations have been used:

PVDF: polyvinylidene fluoride

ITO: tin-doped indium oxide In₂O₃:Sn

PET: polyethylene terephthalate

The “K-glass™” glass used in these examples is a glass covered with an electroconductive layer of SnO₂:F (glass sold under this name by “Pilkington”).

To prepare the PVDF films, use was made of the polyvinylidene fluoride powder manufactured by “Arkema” under the name “Kynarflex® 2821”.

### EXAMPLE 1 (COMPARATIVE)

### Preparation of an Electrochromic Cell

Glass with layer of SnO₂:F
Electroactive system: PVDF+5,10-dihydro-5,10-dimethyl-phenazine+1,1′-diethyl-4,4′-bipyridinium diperchlorate+lithium triflate+propylene carbonate
Glass with layer of SnO₂:F
   Current feed strip welded to the “K-glass” glass over the entire length of one of the four sides of each “K-glass” glass so as to reproduce the configuration of the prior art.

A self-supported film of PVDF was manufactured by mixing 6.5 g of PVDF powder, 13.0 g of dibutylphthalate, 0.5 g of nanoporous silica and 25 g of acetone. The formulation was stirred for two hours and poured onto a sheet of glass. After evaporating the solvent, the PVDF film was removed from the glass sheet under a trickle of water. The film thus obtained has a thickness of around 200 μm.

An electroactive solution was prepared by mixing 0.25 g of 5,10-dihydro-5,10-dimethylphenazine, 0.50 g of 1,1′-diethyl-4,4′-bipyridinium diperchlorate and 0.47 g of lithium triflate in 20 ml of propylene carbonate. The solution was stirred for 1 hour.

The PVDF film having a thickness of around 200 microns was submerged for 5 minutes in diethyl ether (in order to dissolve the dibutylphthalate), then for 5 minutes in the electroactive solution before depositing it on a sheet of “K-glass” glass. A second sheet of “K-glass” was deposited on the electrolyte-impregnated film, a PET frame was used as a spacer around the electroactive medium and clamps were used in order to ensure a good contact between the glass and the film.

The electrochromic device thus manufactured has an active surface area of 8×8 cm² and its performances are reported in Table 1 below:

TABLE 1

| | TL | a* | b* | Switching time |
|---|---|---|---|---|
| Colored state powered at 1.5 V | 1.0 | −19.5 | 3.9 | 30 s for coloring |
| Bleached state in short circuit | 65.9 | −10.2 | 30.2 | 38 s for bleaching |

After having powered this device for 15 h, at ambient temperature, a color segregation was observed in the electroactive medium, which was particularly visible during bleaching, and for several tens of minutes after the short-circuiting of the device as shown in FIG. 9.

### EXAMPLE 2

### Preparation of an Electrochromic Cell

Glass with layer of SnO₂:F
Electroactive system from Example 1
Glass with layer of SnO₂:F
   Current feed strip welded to the “K-glass” glass over the entire periphery of each “K-glass” glass according to the method of the invention.

An electrochromic device, the active surface area of which is 8×8 cm², was manufactured as described in Example 1 and the performances of which are given in Table 2 below:

TABLE 2

| | TL | a* | b* | Switching time |
|---|---|---|---|---|
| Colored state powered at 1.5 V | 0.2 | −3.62 | 0.2 | 5 s for coloring |
| Bleached state in short circuit | 70.4 | −6.0 | 6.2 | 60 s for bleaching |

After having cycled this device for 1000 cycles of coloring at 1.5 V and of bleaching at 0 V, its optical performances remained almost unchanged as is shown in Table 3 below:

TABLE 3

| | TL | a* | b* | Switching time |
|---|---|---|---|---|
| Colored state powered at 1.5 V | 0.2 | −5.2 | 0.2 | 8 s for coloring |
| Bleached state in short circuit | 71.4 | −4.7 | 8.8 | 42 s for bleaching |

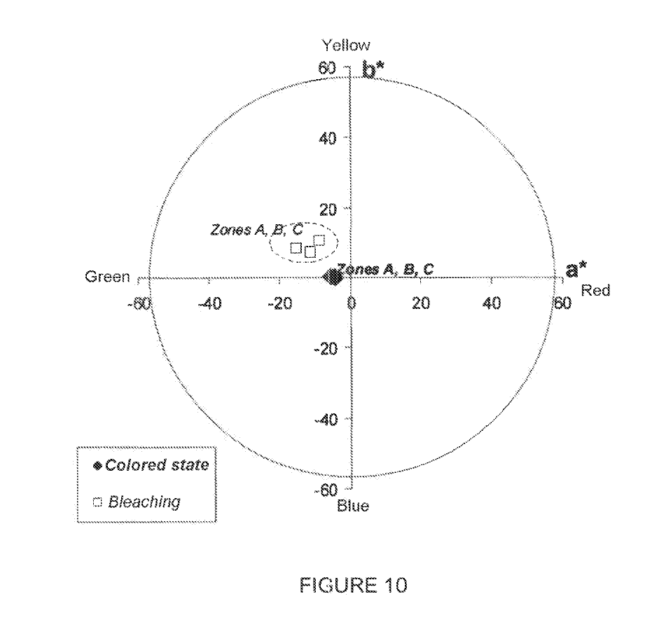

After having powered this device for 15 h, at ambient temperature, no color segregation was observed, including during the bleaching step, as shown in FIG. 10.

### EXAMPLE 3 (REFERENCE)

### Preparation of an Electrochromic Cell

Glass with layer of SnO₂:F
Electroactive system from Example 1
Glass with layer of SnO₂:F
   2.2 cm foils welded to the “K-glass” glass and spaced 4.4 cm apart over the entire periphery, then in series, to each “K-glass” glass, so as to reproduce the configuration described in the United States patent application US 2002/0135881.

An electrochromic device, the active surface area of which is 8×8 cm², was manufactured as described in Example 1 and the performances of which are given in Table 4 below:

TABLE 4

| | TL | a* | b* | Switching time |
|---|---|---|---|---|
| Colored state powered at 1.5 V | 0.2 | −3.84 | 0.5 | 7 s for coloring |
| Bleached state in short circuit | 71.0 | −5.0 | 12.2 | 60 s for bleaching |

After having cycled this device for 1000 cycles of coloring at 1.5 V and of bleaching at 0 V, its optical performances were considerably degraded as is shown in Table 5 below:

TABLE 5

| | TL | a* | b* | Switching time |
|---|---|---|---|---|
| Colored state powered at 1.5 V | 0.4 | −10.5 | 2.5 | 8 s for coloring |
| Bleached state in short circuit | 61.0 | −14.8 | 44.5 | 42 s for bleaching |

### EXAMPLE 4 (COMPARATIVE)

### Preparation of an Electrochromic Cell

Glass with layer of SnO₂:F
Electroactive system: PVDF+ferrocene+1,1′-diethyl-4,4′-bipyridinium diperchlorate+lithium triflate+propylene carbonate
Glass with layer of SnO₂:F
   Current feed strip welded to the “K-glass” glass over the entire length of one of the four sides of each “K-glass” glass so as to reproduce the configuration of the prior art.

An electroactive solution was prepared by mixing 0.17 g of ferrocene, 0.37 g of 1,1′-diethyl-4,4′-bipyridinium diperchlorate and 0.28 g of lithium triflate in 30 ml of propylene carbonate. The solution was stirred for 1 hour.

An electrochromic device, the active surface area of which is 8×8 cm², was manufactured as described in Example 1 and the performances of which are given in Table 6 below:

TABLE 6

| | TL | a* | b* | Switching time |
|---|---|---|---|---|
| Colored state powered at 1.5 V | 10.2 | 3.2 | −49.9 | 17 s for coloring |
| Bleached state in short circuit | 75.8 | −2.5 | 8.9 | 25 s for bleaching |

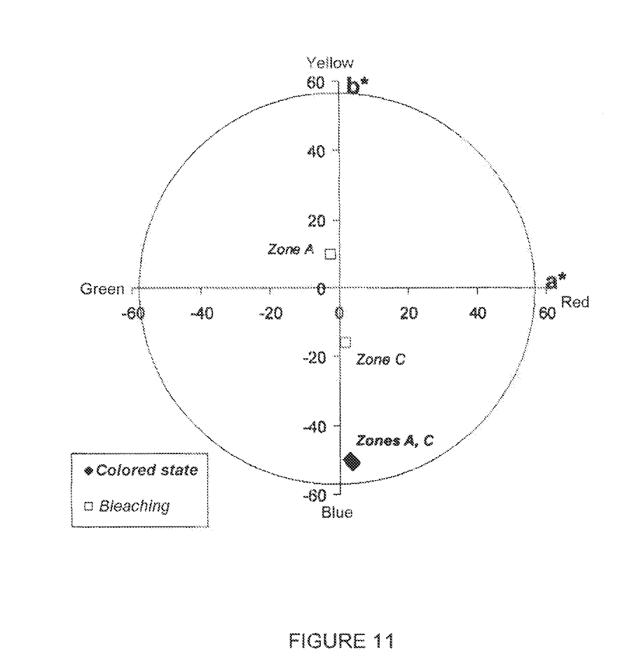

After having powered this device for 30 h, at ambient temperature, a color segregation was observed in the electroactive medium, which was particularly visible during bleaching, and for several tens of minutes after the short-circuiting of the cell as shown in FIG. 11.

### EXAMPLE 5

### Preparation of an Electrochromic Cell

Glass with layer of SnO₂:F
Electroactive system from Example 4
Glass with layer of SnO₂:F
   Current feed strip welded to the “K-glass” glass over the entire periphery of each “K-glass” glass according to the method of the invention.

An electrochromic device, the active surface area of which is 8×8 cm², was manufactured as described in Example 1 and the performances of which are given in Table 7 below:

TABLE 7

| | TL | a* | b* | Switching time |
|---|---|---|---|---|
| Colored state powered at 1.5 V | 9.6 | 3.8 | −50.3 | 14 s for coloring |
| Bleached state in short circuit | 76.0 | −2.4 | 9.3 | 27 s for bleaching |

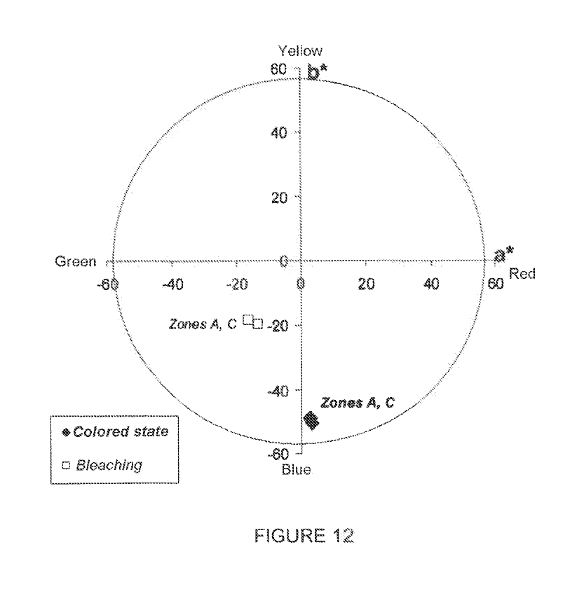

After having powered this device for 30 h, at ambient temperature, no color segregation was observed, including during the bleaching step, as shown in FIG. 12.

### EXAMPLE 6 (COMPARATIVE)

### Preparation of an Electrochromic Cell

Glass with layer of SnO₂:F
Electroactive system from Example 4
Glass with layer of SnO₂:F
   Current feed strip welded to the “K-glass” glass over the entire length of one of the four sides of each “K-glass” glass so as to reproduce the configuration of the prior art.

An electrochromic device, the active surface area of which is 22×22 cm², was manufactured as described in Example 1 and the performances of which are given in Table 8 below:

TABLE 8

| | TL | a* | b* | Switching time |
|---|---|---|---|---|
| Colored state powered | 38.0 | −12.9 | −18.4 | 112 s for coloring |
| at 1.5 V | | | | |
| Bleached state in short circuit | 75.8 | −2.6 | 10.4 | 53 s for bleaching |

### EXAMPLE 7

### Preparation of an Electrochromic Cell

Glass with layer of SnO₂:F
Electroactive system from Example 4
Glass with layer of SnO₂:F
   Current feed strip welded to the “K-glass” glass over the entire periphery of each “K-glass” glass according to the method of the invention.

An electrochromic device, the active surface area of which is 22×22 cm², was manufactured as described in Example 1 and the performances of which are given in Table 9 below:

TABLE 9

| | TL | a* | b* | Switching time |
|---|---|---|---|---|
| Colored state powered at 1.5 V | 7.4 | 7.6 | −52.3 | 24 s for coloring |
| Bleached state in short circuit | 75.6 | −2.5 | 10.6 | 45 s for bleaching |

### EXAMPLE 8

### Preparation of an Electrochromic Cell

Glass with layer of SnO₂:F
Electroactive system: PVDF+ferrocene+5,10-dihydro-5,10-dimethylphenazine+1,1′-diethyl-4,4′-bipyridinium diperchlorate+lithium triflate+propylene carbonate
Glass with layer of SnO₂:F
   Current feed strip welded to the “K-glass” glass over the entire periphery of each “K-glass” glass according to the method of the invention.

An electroactive solution was prepared by mixing 0.11 g of ferrocene, 0.15 g of 5,10-dihydro-5,10-dimethylphenazine, 0.50 g of 1,1′-diethyl-4,4′-bipyridinium diperchlorate and 0.47 g of lithium triflate in 20 ml of propylene carbonate. The solution was stirred for 1 hour.

An electrochromic device, the active surface area of which is 8×8 cm², was manufactured as described in Example 1 and the performances of which are given in Table 10 below:

TABLE 10

| | TL | a* | b* | Switching time |
|---|---|---|---|---|
| Colored state powered at 1.5 V | 0.3 | −5.25 | −1.63 | 8 s for coloring |
| Bleached state in short circuit | 74.1 | −4.06 | 11.02 | 49 s for bleaching |

After having cycled this device for 500 cycles of coloring at 1.5 V and of bleaching at 0 V, its optical performances remained almost unchanged as is shown in Table 11 below:

TABLE 11

| | TL | a* | b* | Switching time |
|---|---|---|---|---|
| Colored state powered at 1.5 V | 0.3 | −4.8 | −2.2 | 8 s for coloring |
| Bleached state in short circuit | 73.2 | −3.8 | 11.5 | 47 s for bleaching |

### EXAMPLE 9

### Preparation of an Electrochromic Cell

Glass with layer of SnO₂:F
Electroactive system: PVDF+5,10-dihydro-5,10-dimethylphenazine+1,1′-diethyl-4,4′-bipyridinium diperchlorate+lithium triflate+propylene carbonate
Glass with layer of SnO₂:F
   Current feed strip welded to the “K-glass” glass over the entire periphery of each “K-glass” glass according to the method of the invention.

An electroactive solution was prepared by mixing 0.12 g of 5,10-dihydro-5,10-dimethylphenazine, 0.25 g of 1,1′-diethyl-4,4′-bipyridinium diperchlorate and 0.47 g of lithium triflate in 20 ml of propylene carbonate. The solution was stirred for 1 hour.

An electrochromic device, the active surface area of which is 8×8 cm², was manufactured as described in Example 1 and the performances of which are given in Table 12 below:

TABLE 12

| | TL | a* | b* | Switching time |
|---|---|---|---|---|
| Colored state powered at 1.5 V | 3.9 | −34.8 | 4.1 | 10 s for coloring |
| Bleached state in short circuit | 76.3 | −2.8 | 5.6 | 37 s for bleaching |

After having cycled this device for 500 cycles of coloring at 1.5 V and of bleaching at 0 V, its optical performances remained almost unchanged as is shown in Table 13 below:

TABLE 13

| | TL | a* | b* | Switching time |
|---|---|---|---|---|
| Colored state powered at 1.5 V | 4.2 | −35.2 | 3.2 | 13 s for coloring |
| Bleached state in short circuit | 75.7 | −2.6 | 6.1 | 27 s for bleaching |

### EXAMPLE 10 (COMPARATIVE)

### Preparation of an Electrochromic Cell

Glass with layer of ITO
Electroactive system from Example 1
   Current feed strip welded to the glass with layer of ITO over the entire length of one of the four sides of each glass with a layer of ITO so as to reproduce the configuration of the prior art.

An electrochromic device, the active surface area of which is 8×8 cm², was manufactured as described in Example 1, and the performances of which are given in Table 14 below:

TABLE 14

| | TL | a* | b* | Switching time |
|---|---|---|---|---|
| Colored state powered at 1.5 V | 0.7 | −14.1 | 3.5 | 8 s for coloring |
| Bleached state in short circuit | 63.0 | −13.8 | 39.0 | 28 s for bleaching |

### EXAMPLE 11

### Preparation of an Electrochromic Cell

Glass with layer of ITO
Electroactive system from Example 1
   Current feed strip welded to the glass with a layer of ITO over the entire periphery of each “K-glass” glass according to the method of the invention.

An electrochromic device, the active surface area of which is 8×8 cm², was manufactured as described in Example 1, the performances of which are given in Table 15 below:

TABLE 15

| | TL | a* | b* | Switching time |
|---|---|---|---|---|
| Colored state powered at 1.5 V | 0.3 | −6.4 | 0.8 | 4 s for coloring |
| Bleached state in short circuit | 68.0 | −7.0 | 19.0 | 34 s for bleaching |

1. An electrically controllable device having variable optical/energy properties, comprising:
(A) a first substrate having a glass function;
(B) a first electronically conductive layer with an associated current feed;
(C) an electroactive medium comprising:
at least one electroactive organic compound, ea₁⁺, capable of being reduced and/or of accepting electrons and cations acting as compensation charges;
at least one electroactive organic compound (ea₂) capable of being oxidized and/or of ejecting electrons and cations acting as compensation charges;
at least one of said electroactive organic compounds (ea₁⁺ and ea₂) being electrochromic in order to obtain a color contrast; and
ionic charges capable of allowing, under the action of an electric current, oxidation and reduction reactions of said electroactive organic compounds (ea₁⁺ and ea₂), which reactions are necessary in order to obtain the color contrast;
(D) a second electronically conductive layer with an associated current feed; and
(E) a second substrate having a glass function,
wherein each current feed comprises a continuous conductive strip applied to the electronically conductive layer associated with it,
wherein the conductive strip is positioned over an entire perimeter or substantially over the entire perimeter of the first or second electronically conductive layer so as to strengthen the conductivity of the first or second electronically conductive layer,
wherein the conductive strip is connected to an electrical power supply via one of its ends, and
wherein the two continuous conductive strips are placed with an offset relative to one another.

2. The device of claim 1, wherein the conductive strip is applied to each electronically conductive layer, along a first edge of said layer and, at its end opposite a start of the strip, the conductive strip is folded upon itself at 90° in order to be applied along second edge of the layer perpendicular to the first edge, then again at 90° in order to be applied along a third edge, opposite to the first, and finally at 90° in order to be applied in the vicinity of a remaining edge, stopping in the vicinity of the start of the strip, this strip jutting out beyond a stack of layers that forms the electrically controllable device in order to form a connection with an electrical power supply.

3. The device of claim 2, wherein two substrates having a glass function, coated internally by the first or second electronically conductive layer, are separated by a peripheral spacer frame that delimits, with the first and the second electrically conductive layers, an internal space for receiving the electroactive medium, and the two substrates are sealed by a peripheral seal, wherein each conductive strip is applied, via one of its faces, to the first and the second electrically conductive layer associated, and via its other face against said spacer frame.

4. The device of claim 2, wherein the continuous peripheral conductive strip is deposited by screen printing onto each of the electronically conductive layers and a foil is applied to the start of said strip so as to jut out beyond a stack of layers that forms the electrically controllable device in order to form a connection with an electrical power supply.

5. The device of claim 1, wherein a grid pattern supplied by the conductive strip associated is formed on a surface of at least one electronically conductive layer.

6. The device of claim 1, wherein the substrates having a glass function are at least one selected from glass and a transparent polymer.

7. The device of claim 1, wherein the electronically conductive layers are metallic layers; or transparent conductive oxide (TCO) layers a TCO/metal/TCO multilayer, or a NiCr/metal/NiCr multilayer.

8. The device of claim 1, wherein the first and second electronically conductive layers are in the form of a grid or a microgrid.

9. The device of claim 1, wherein the first and second electronically conductive layers comprise an organic underlayer, an inorganic underlayer, and an organic and inorganic underlayer.

10. The electrically controllable device of claim 1, wherein the electroactive medium comprises a self-supported polymer matrix, inserted into which are the electroactive organic compounds, ea₁⁺ & ea₂, and the ionic charges, wherein the polymer matrix comprising within it a liquid that solubilizes the electroactive compounds, ea₁⁺ & ea₂, and also respectively associated reduced and oxidized species, ea₁⁺ & ea₂, and the ionic charges, but that does not solubilize the self-supported polymer matrix, wherein the matrix provides a percolation pathway for ionic charges in order to make said oxidation and reduction reactions of the electroactive organic compounds, ea₁⁺ & ea₂, possible;
wherein the ionic charges are borne by at least one selected from the group consisting of the electroactive organic compound, ea₁, the electroactive organic compound, ea₂⁺, a reduced species, ea₁, an oxidized species, ea₂⁺, an ionic salt, an acid solubilized in the liquid (L), and the self-supported polymer matrix;
wherein the liquid (L) comprises at least one selected from the group consisting of a solvent, an ionic liquid, and a molten salt at ambient temperature, wherein liquid (L) bears ionic charges, which charges represent all or some of the ionic charges of the electroactive system.

11. The device of claim 1, wherein the electroactive medium comprises a solution or a gel comprising the electroactive organic compounds, ea₁⁺ & ea₂.

12. The device of claim 1, wherein the electroactive medium is a self-supported and plasticized polymer film comprising the electroactive organic compounds, ea₁⁺ & ea₂.

13. The device of claim 1, wherein the at least one electroactive organic compound, ea₁⁺, is selected from the group consisting of a bipyridinium, or a viologen a pyrazinium, a pyrimidinium, a quinoxalinium, a pyrylium, a pyridinium, a tetrazolium, a verdazyl, a quinone, quinodimethane, a tricyanovinylbenzene, a tetracyanoethylene, a polysulfide and a disulfide, and an electroactive polymer derivative thereof; and
the at least one electroactive organic compound, ea₂, is selected from the group consisting of a metallocene, N,N,N′,N′-tetramethylphenylenediamine (TMPD), a phenothiazine, a dihydrophenazine reduced methylphenothiazone (MPT), methylene violet bernthsen (MVB), a verdazyl, and an electroactive polymer derivative thereof.

14. The device of claim 10, wherein, at least one of:
the at least one ionic salt is present and is selected from the group consisting of lithium perchlorate, a trifluoromethanesulfonate salt, a triflate salt, a trifluoromethanesulfonylimide salt, and an ammonium salt;
the at least one acid is present and is selected from the group consisting of sulfuric acid (H₂SO₄), triflic acid (CF₃SO₃H), phosphoric acid (H₃PO₄), and polyphosphoric acid (Hₙ₊₂PₙO₃ₙ₊₁);
the solvent is present and is selected from the group consisting of dimethylsulfoxide, N,N-dimethylformamide, N,N-dimethylacetamide, propylene carbonate, ethylene carbonate, N-methyl-2-pyrrolidone (1-methyl-2-pyrrolidinone), γ-butyrolactone, an ethylene glycol, an alcohol, a ketone, a nitrile, and water; and
the at least one ionic liquid is present and is an imidazolium salt.

15. The device of claim 1, the form of:
a vehicle sunroof, a sunroof for a motor vehicle, that can be activated autonomously, or a side window or a rear window for a motor vehicle or a rear view mirror;
a windshield or a portion of a windshield of a motor vehicle, of an aircraft, or of a ship;
an aircraft cabin window;
a display panel for displaying at least one of graphical information and alphanumeric information;
an interior or exterior glazing unit for a building;
a skylight;
a display cabinet or store counter;
a glazing unit for protecting an image-bearing or painted object;
an anti-glare computer screen;
glass furniture; or
a wall for separating two rooms inside a building.

16. The device of claim 1, wherein the offset between the two continuous conductive strips is less than or equal to 2 cm.

17. The device of claim 1, wherein the substrates having a glass function are at least one selected from glass, polymethyl methacrylate (PMMA), polycarbonate (PC), polyethyleneterephthalate (PET), polyethylene naphthoate (PEN), and a cycloolefin copolymer (COC).

18. The device of claim 7, wherein at least one of the first and the second electronically conductive layer is at least one metallic layer selected from the group consisting of a silver layer, a gold layer, a platinum layer, and a copper layer.

19. The device of claim 7, wherein at least one of the first and the second electronically conductive layer is at least one transparent conductive oxide layer selected from the group consisting of a tin-doped indium oxide (In₂O₃:Sn or ITO) layer, an antimony-doped indium oxide (In₂O₃:S₆) layer, a fluorine-doped tin oxide (SnO₂:F) layer, and an aluminum-doped zinc oxide (ZnO:Al) layer.

20. The device of claim 14, wherein the ionic liquid is present and is selected from the group consisting of 1-ethyl-3-methylimidazolium tetrafluoroborate (emim-BF₄), 1-ethyl-3-methylimidazolium trifluoromethane sulfonate (emim-CF₃SO₃), 1-ethyl-3-methylimidazolium bis(trifluoromethyl sulfonyl)imide (emim-N(CF₃SO₂)₂ or emim-TSFI), and 1-butyl-3-methylimidazolium bis(trifluoromethylsulfonyl)imide (bmim-N(CF₃SO₂)₂ or bmim-TSFI).
